(19) United States
(12) Patent Application Publication
(10) Pub. No.: US 2023/0379757 A1
(43) Pub. Date: Nov. 23, 2023

(54) USER EQUIPMENT, NETWORK NODE AND METHODS IN A WIRELESS COMMUNICATIONS NETWORK

(71) Applicant: Telefonaktiebolaget LM Ericsson (publ), Stockholm (SE)

(72) Inventors: Mohammad MOZAFFARI, Fremont, CA (US); Yi-Pin Eric WANG, Fremont, CA (US); Kittipong KITTICHOKECHAI, Jarfalla (SE); Mehrnaz AFSHANG, Fremont, CA (US); Sandeep Narayanan KADAN VEEDU, Taby (SE); Zhilan XIONG, Solna (SE)

(21) Appl. No.: 17/747,802

(22) Filed: May 18, 2022

(51) Int. Cl. H04W 28/06; H04W 56/00

(52) U.S. Cl. CPC H04W 28/06; H04W 56/001

(57) ABSTRACT

A method performed by a User Equipment (UE) for handling a Synchronization Signal Block (SSB) from a network node in a wireless communications network is provided. The UE operates with a reduced bandwidth. The UE detects an SSB from the network node, and that a bandwidth of the SSB is larger than the bandwidth of the UE. The UE determines which part of the SSB to skip to make the bandwidth of the SSB equal or smaller than the bandwidth of the UE, such that the UE is capable of receiving the SSB. The part of the SSB to be skipped is determined based on a predicted decoding performance of the SSB.

### TECHNICAL FIELD

Embodiments herein relate to a User Equipment (UE), a network node and methods therein. In some aspects, they relate to handling of a Synchronization Signal Block (SSB), in a wireless communications network.

### BACKGROUND

In a typical wireless communication network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

### Internet of Things (IoT) and Reduced Capability NR Devices

A next paradigm shift in processing and manufacturing is the Industry 4.0 in which factories are automated and made much more flexible and dynamic with the help of wireless connectivity. This includes real-time control of robots and machines using time-critical Machine-Type Communication (cMTC) and improved observability, control, and error detection with the help of large numbers of more simple actuators and sensors e.g., Massive Machine-Type Communication (mMTC). For cMTC support, URLLC was introduced in 3GPP Release 15 for both LTE and NR, and NR URLLC is further enhanced in Release 16 within the enhanced Ultra Reliable Low Latency Communications (eURLLC) and Industrial IoT work items.

For mMTC and Low Power Wide Area (LPWA) support, 3GPP introduced both Narrowband Internet-of-Things (NB-IoT) and Long-Term Evolution for Machine-Type Communication (LTE-MTC, or LTE-M) in Release 13. These technologies have been further enhanced through all releases up until and including the ongoing Release 16 work.

NR was introduced in 3GPP Release 15 and focused mainly on enhanced Mobile Broadband (eMBB) and cMTC. However, there are still several other use cases whose requirements are higher than those of LPWA networks, i.e., LTE-M/NB-IoT, but lower than those of URLLC and eMBB. In order to efficiently support such use cases which are in-between eMBB, URLLC, and mMTC, 3GPP has studied Reduced Capability NR devices (RedCap) in Release 7. The RedCap study item was completed in March 2021. A corresponding RedCap work item was started in December 2020 and is expected to be finalized in September 2022.

The RedCap UEs are required to have lower cost, lower complexity, a longer battery life, and potentially a smaller form factor than legacy NR UEs. Therefore, several different complexity reduction features will be specified for RedCap UEs in Release 17. These complexity reduction features are listed in the Release 17 work item description (WID) for RedCap. In particular, the reduced maximum UE bandwidth for Release 17 RedCap are as follows:

Reduced maximum UE bandwidth for Release 17 RedCap:
Maximum bandwidth of an FR1 RedCap UE during and after initial access is 20 MHz.
Maximum bandwidth of an FR2 RedCap UE during and after initial access is 100 MHz.

Moreover, in Release 18 enhanced RedCap (eRedCap) there will be a study on further UE bandwidth reduction.

### Release 18 eRedCap

Many industrial sensors use cases require a deployment of a massive number of sensors. Replacing the battery of each of these sensors might be prohibitively difficult or undesirable. In certain use cases, it might be difficult to access or even exactly locate the sensors after they have been deployed. Thus, for these use cases, a key enabler is to allow the sensors to sustain decades of operation without ever needing battery replacement. Furthermore, many of the sensor use cases operate in environments where it is possible to harvest ambient energy for operation. The harvested ambient energy may be, for example, vibrational energy, photovoltaic energy, thermal-electric generated energy.

Some of these considerations are also applicable to video surveillance and medical wearable use cases. For example, a video surveillance camera deployed outdoors may harvest solar energy. A medical wearable device may be able to harvest energy through vibration and it may be desirable that the patients do not need to replace battery themselves (i.e., battery lasts between office visits).

To further expand the market for RedCap use cases with relatively low cost, low energy consumption, and low data rate requirements, e.g., industrial wireless sensor network use cases, some further cost and complexity reduction enhancements can be considered. The enhancements can aim at supporting lower UE peak data rate and energy consumption compared to Release 17, while ensuring Release 17 compatibility.

To further expand the RedCap use cases, the following enhancements may be considered:
UE cost/complexity reduction: Further UE complexity/cost reduction without fundamental changes to the Release 17 basic RedCap UE type may be motivated to enable the uptake of RedCap UE in low-end use cases.
   Study further reduced UE bandwidth: There exist different solutions to support use cases requiring low cost and low peak data rates. approach is based on further reducing maximum supported UE bandwidth, e.g., to 5 MHz in FR1. There are trade-offs between expected cost/complexity reduction, specification impacts, and network impacts especially the compatibility with Release 17 and coexistence of RedCap and non-RedCap UEs. It is not clear if the additional cost saving gain is justified.

For support of UEs with different capabilities, e.g., bandwidth, in a network, it is important to ensure an efficient coexistence of different UEs while considering resource utilization, network spectral/energy efficiency, and scheduling complexity.

### Initial Access

A first step in an initial access is that a UE detects DL synchronization reference signals, including Primary Synchronization Signal (PSS) and Secondary Synchronization Signal (SSS). Following that the UE reads a Physical Broadcast Channel (PBCH) which includes a Master Information Block (MIB). Among other information, MIB comprises Physical Downlink Control Channel (PDCCH)-Configured System Information Block 1 (SIB1, PDCCH-ConfigSIB1) which is the configuration of CORESET #0. After decoding CORESETO which is the DL assignment for the remaining system information, the UE can receive the SIB1, which includes the Random Access Channel (RACH) configuration.

Random access is the procedure of UE accessing a cell, receiving a unique identification by the cell and receiving the basic radio resource configurations. The steps of four-step random access are as follows:
the UE transmits a preamble referred to as Physical Random Access Channel (PRACH)
the Network sends random access response (RAR), indicating reception of preamble and provides time-alignment command,
the UE sends a PUSCH, a.k.a., Message 3, aiming at resolving collision
The Network sends the contention resolution message, a.k.a., Message 4
The UE sends the ACK/NACK for Msg4 on the Physical Uplink Control Channel (PUCCH).

NR SSB

During cell search a UE aims at acquiring time and frequency synchronization with a cell and to detect physical layer cell ID (PCI) of the cell. In NR, the SSB comprises PSS and SSS and PBCH. During the initial cell search, the UE first aims at detecting PSS and then SSS. Time and frequency synchronization as well as cell ID detection are done using PSS and SSS. Proper detection of PSS and SSS is an essential step for PBCH demodulation. PBCH carries basic system information such as MIB and determines essential parameters for initial access of the cell including the downlink system bandwidth and the system frame number. For PBCH, polar coding and Quadrature Phase Shift Keying (QPSK) modulation are used. The SSB periodicity may be {5, 10, 20, 40, 80, 160} ms, configured via RRC parameters. However, a default periodicity of 20 ms is assumed during initial cell search. To support initial access and beam management, NR supports SS burst set which consists of multiple SSBs confined within a 5 ms window. Depending on the carrier frequency, up to 64 SSBs can be transmitted within a SS burst set.

In a frequency domain, one SSB block occupies 20 contiguous resource blocks which is equivalent to 240 subcarriers, as illustrated in FIG. 1. In time domain, one SSB block spans over four (4) Orthogonal Frequency Division Multiplexing (OFDM) symbols referred to as 11 in FIG. 1. Among the four symbols, one symbol is for PSS, one symbol is for SSS, and two symbols are for PBCH. Specifically, PSS occupies the first OFDM symbol of SSB and spans over 127 subcarriers. SSS is located in the third OFDM symbol of SSB and spans over 127 subcarriers. The total number of Resource Elements (REs) used for PBCH transmission per SSB is 576. There are, however, 113 (57+56) unused subcarriers in the first symbol, and 17 (9+7) unused subcarriers in the thirds symbol, as shown in FIG. 1. Therefore, there are 130 (113+17) unused REs within an SSB. In the current NR design, the complex-valued symbols corresponding to these unused REs are set to zero.

The SSB bandwidth depends on the Subcarrier Spacing (SCS) as provided in Table 1.

Table 1
SSB bandwidth for different SCSs.

| | SSB Bandwidth |
|---|---|
| SSB SCS | (240 subcarriers) |
| 15 KHz | 3.6 MHz |
| 30 KHz | 7.2 MHz |
| 120 KHz | 28.8 MHz |
| 240 KHz | 57.6 MHz |

In order to receive SSB with 240 kHz SCS, the minimum guardband for each UE channel bandwidth is specified in 3GPP R1-2110385, “RAN1 agreements for Release 17 NR RedCap”, see Table 5.3.3-2 in this documents, and as provided in Table 2. The minimum guardband is applicable only when the SCS 240 kHz SSB is received adjacent to the edge of the UE channel bandwidth within which the SSB is located. That is, a minimum guardband is needed between an SSB (240 kHz SCS) and edges of UE channel bandwidth.

TABLE 2
Minimum guardband (kHz) of SCS 240 KHz SSB.

| SCS (KHz) | 100 MHz | 200 MHz | 400 MHZ |
|---|---|---|---|
| 240 | 3800 | 7720 | 15560 |

The possible locations of SSB within an NR carrier may be identified based on the synchronization raster. The synchronization raster indicates the possible frequency locations of the SSB which can be used by the UE for system acquisition when explicit signaling of the SSB location is not available.

### SUMMARY

As a part of developing embodiments herein a problem was identified by the inventors and will first be discussed.

As previously discussed, UE bandwidth reduction is identified as one of the important ways to reduce the UE complexity as well as power consumption. However, it is highly desired that the Release 15 SSB Bandwidth (BW) should be reused when introducing reduced capability UEs. Consequently, depending on the UE BW and SSB configuration, BW reduction may impact SSB performance. In FR1, the SSB supports 15 kHz and 30 kHz subcarrier spacing, which corresponds to 3.6 MHz and 7.2 MHz bandwidth, respectively. In FR2, the SSB supports 120 kHz and 240 kHz subcarrier spacing, which corresponds to 28.8 MHz and 57.6 MHz bandwidth, respectively. Therefore, the performance of SSB can be degraded when UE BW is less than 7.2 MHz in FR1 or less than 57.6 MHz in FR2.

Table 3 below, for FR1, shows different channels/signals which may not be fully supported depending on the UE maximum bandwidth. As another example in FR2, a UE supporting a 50 MHz maximum bandwidth cannot fully support SSB with 240 kHz SCS. In addition, the support of 240 kHz SCS SSB requires satisfying additional guardband requirements, which affects the reception of SSB for reduced BW UEs. Therefore, there is a need for methods to enable a UE with reduced BW to receive SSB which has larger bandwidth than the UE BW, while minimizing the performance degradation.

TABLE 3
Different configurations which are not fully supported due to further UE bandwidth reduction
since the channel BW exceeds the UE BW.

| Channel/signal | 5 MHZ UE BW | 3 MHz UE BW | 1 MHz UE BW |
|---|---|---|---|
| SSS/PSS (15 KHz SCS) | Supported | Supported | Not supported |
| PBCH (15 KHz SCS) | Supported | Not supported | Not supported |
| SSS/PSS (30 KHz SCS) | May not be supported | Not supported | Not supported |
| | (if guardband needed) | | |
| PBCH (30 KHz SCS) | Not supported | Not supported | Not supported |

An object of embodiments herein is improve the way of receiving SSBs for a UE operating with reduced bandwidth in a wireless communications network.

According to an aspect of embodiments herein, the object is achieved by a method performed by a UE for handling a SSB from a network node in a wireless communications network. The UE operates with a reduced bandwidth. The UE detects an SSB from a network node, and that a bandwidth of the SSB is larger than the bandwidth of the UE. The UE determines which part of the SSB to skip to make the bandwidth of the SSB equal or smaller than the bandwidth of the UE, such that the UE is capable to receive the SSB. The part of the SSB to be skipped is determined based on a predicted decoding performance of the SSB.

According to another aspect of embodiments herein, the object is achieved by a method performed by a network node for handling SSBs in a wireless communications network. The network node sends an SSB to a UE. The UE operates with a reduced bandwidth. The SSB comprises unused parts. When a bandwidth of the SSB is larger than the bandwidth of the UE, the network node receives a message from the UE. The message indicates a part or parts of the SSB that are determined to be skipped in order to make the bandwidth of the SSB equal or smaller than the bandwidth of the UE, such that the UE is capable to receive the SSB. The network node prepares a second SSB such that the UE 120 is capable to receive the SSB, based on the indicated part or parts of the SSB that are determined to be skipped and the unused parts of the SSB, such that in the second SSB the unused parts are replaced by the parts of the SSB that was determined to be skipped, making the bandwidth of the second SSB equal or smaller than a bandwidth of a second UE operating with a reduced bandwidth. The network node sends the second SSB to the second UE 122.

According to another aspect of embodiments herein, the object is achieved by a UE configured to handle an SSB from a network node in a wireless communications network. The UE is adapted to operate with a reduced bandwidth. The UE is further configured to:
detect an SSB from a network node, and that a bandwidth of the SSB is larger than the bandwidth of the UE,
determine which part of the SSB to skip to make the bandwidth of the SSB equal or smaller than the bandwidth of the UE, such that the UE is capable to receive the SSB, wherein the part of the SSB to be skipped is adapted to be determined based on a predicted decoding performance of the SSB.

According to another aspect of embodiments herein, the object is achieved by a network node configured to handle SSBs in a wireless communications network. The network node is further configured to:
send an SSB to a UE, which UE is adapted to operate with a reduced bandwidth, which SSB comprises unused parts,
when a bandwidth of the SSB is larger than the bandwidth of the UE, receive a message from the UE, which message is adapted to indicate a part or parts of the SSB that are determined to be skipped in order to make the bandwidth of the SSB equal or smaller than the bandwidth of the UE, such that the UE is capable to receive the SSB,
prepare a second SSB such that the UE 120 is capable to receive the SSB, based on the indicated part or parts of the SSB that are determined to be skipped and the unused parts of the SSB, such that in the second SSB the unused parts are replaced by the parts of the SSB that was determined to be skipped, making the bandwidth of the second SSB equal or smaller than a bandwidth of a second UE operating with a reduced bandwidth, and
send the second SSB to the second UE.

Thanks to that the UE has determined which part of the SSB to skip based on a predicted decoding performance of the SSB, which will make the bandwidth of the SSB equal or smaller than the bandwidth of the UE, the UE will be capable to receive the SSB.

In this way an SSB with a bandwidth that is larger than the bandwidth of the UE can be received by the UE while minimizing the performance degradation. This results in an improved way of receiving SSBs for the UE operating with reduced bandwidth in the wireless communications network.

### BRIEF DESCRIPTION OF THE DRAWINGS

Examples of embodiments herein are described in more detail with reference to attached drawings in which:

FIG. 1 is a schematic block diagram illustrating prior art.

FIG. 2 is a schematic block diagram illustrating embodiments of a wireless communications network.

FIG. 3 is a flowchart depicting an embodiment of a method in a UE.

FIG. 4 is a flowchart depicting an embodiment of a method in a network node.

FIG. 5 is a schematic block diagram illustrating embodiments herein.

FIG. 6 is a schematic block diagram illustrating embodiments herein.

FIG. 7 is a schematic block diagram illustrating embodiments herein.

FIG. 8a-b are schematic block diagrams illustrating embodiments of a network node.

FIG. 9a-b are schematic block diagrams illustrating embodiments of a gateway device.

FIG. 10 schematically illustrates a telecommunication network connected via an intermediate network to a host computer.

FIG. 11 is a generalized block diagram of a host computer communicating via a base station with a user equipment over a partially wireless connection.

FIGS. 12-15 are flowcharts illustrating methods implemented in a communication system including a host computer, a base station and a user equipment.

### DETAILED DESCRIPTION

Embodiments herein relate to SSBs for reduced bandwidth UEs.

Embodiments herein provide effective mechanisms that enable a UE such as a reduced bandwidth UE to receive an SSB which is larger than the UE receiver bandwidth.

In particular, some examples of the provided methods determine the portion of an SSB which shall be skipped at the UE while ensuring a minimum impact on the PSS/SSS/PBCH decoding performance.

In addition, some embodiments herein provide techniques for compensating any loss that reduced bandwidth UE, also referred to as a reduced BW UE herein, may experience when receiving an SSB exceeding the UE bandwidth.

Embodiments provided herein enable a reduced BW UE to effectively receive an SSB whose bandwidth exceeds the UE BW. Specifically, the provided schemes of example embodiments herein ensure the minimum impact on detecting the SSB by identifying suitable SSB subcarriers which preferably should be skipped at the receiver. Techniques according to embodiments herein are particularly useful when the SSB is shared between legacy UEs and reduced BW UEs. Hence, embodiments herein are beneficial for network resource utilization and SSB decoding performance for reduced BW UEs. Examples of embodiments herein are important for supporting ultra-low cost, low power, and low complexity devices, also referred to as UEs, in 5G evolution towards 6G.

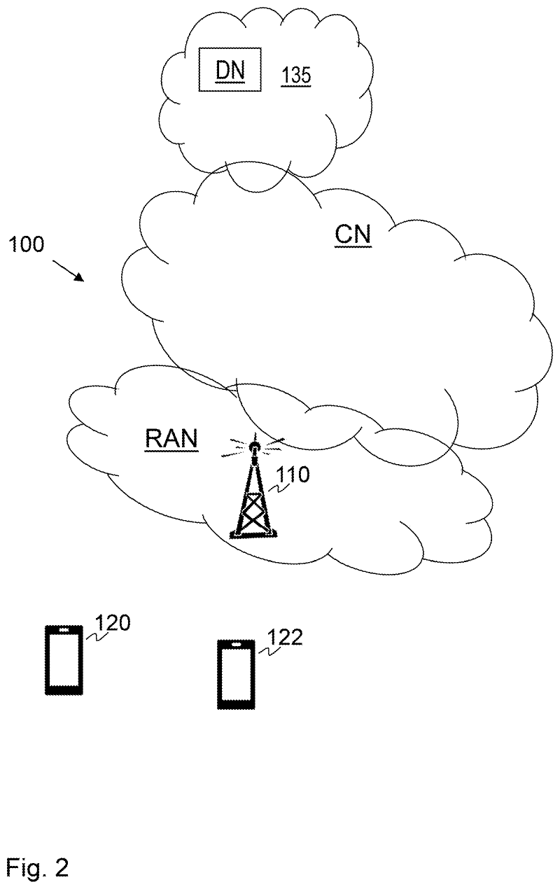

FIG. 2 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, 6G, Wi-Fi, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes, such as a network node 110, operate in the wireless communications network 100. The network node 110 e.g. provides a number of cells and may use these cells for communicating with e.g. a UE 120 and/or a second UE 122. The network node 110 may be a transmission and reception point e.g. a radio access network node such as a base station, e.g. a radio base station such as a NodeB, an evolved Node B (eNB, eNodeB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the network node 110 depending e.g. on the radio access technology and terminology used. The network node 110 may further be able to control, e.g. schedule, communication on a number of SL beams between UEs, e.g. the UE 120 and the second UE 122.

UEs operate in the wireless communications network 100, such as e.g. a UE 120 and/or a second UE 122. The UE 120 and the second UE 122 may operate with a reduced bandwidth and may be referred to as reduced BW UEs herein. Any one or both of the UE 120 and the second UE 122 may respectively e.g. be an NR device, a mobile station, a wireless terminal, an NB-IoT device, an enhanced Machine Type Communication (eMTC) device, an NR RedCap device, a CAT-M device, a Vehicle-to-everything (V2X) device, Vehicle-to-Vehicle (V2V) device, a Vehicle-to-Pedestrian (V2P) device, a Vehicle-to-Infrastructure (V2I) device, and a Vehicle-to-Network (V2N) device, a Wi-Fi device, an LTE device and a non-access point (non-AP) STA, a STA, that communicates via a base station such as e.g. the network node 110, one or more Access Networks (AN), e.g. RAN, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

Methods herein may in one aspect be performed by the UE 120, in another aspect by the network node 110. As an alternative, a Distributed Node (DN) and functionality, e.g. comprised in a cloud 135 as shown in FIG. 2, may be used for performing or partly performing the methods of embodiments herein.

According to example embodiments herein reduced BW UEs such as the UE 120, is capable of decoding an SSB whose bandwidth exceeds the UE 120 received bandwidth. Embodiments herein enable the UE 120 to efficiently skip a portion of SSB which has a minimum impact on the SSB decoding performance. The network may also effectively support legacy UEs and reduced BW UEs such as e.g. the second UE 122, using a shared SSB which is beneficial from resource utilization perspective.

In some embodiments herein, when the bandwidth of SSB is larger than the UE 120 bandwidth, the UE 120 efficiently determines which part of SSB to skip, also referred to as omit or puncture, such that the impact on the decoding is minimized, i.e., minimizing the performance loss. This scenario is particularly advantageous for supporting UEs with reduced bandwidth also referred to as reduced capability, which may not fully receive the transmitted signal from the network node 110.

A number of embodiments will now be described, some of which may be seen as alternatives, while some may be used in combination.

### Method in the UE 120.

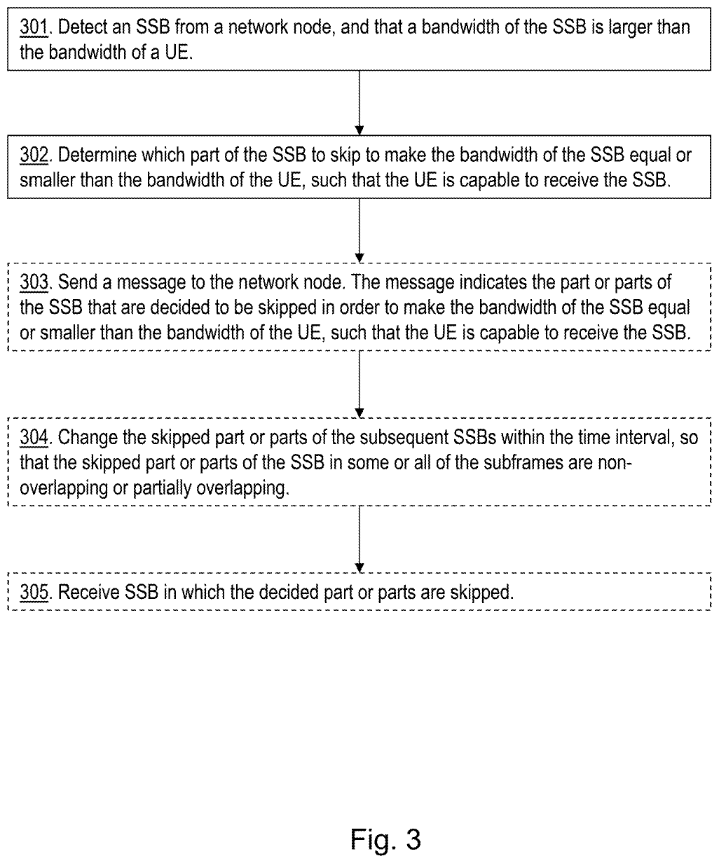

FIG. 3 shows example embodiments of a method performed by the UE 120. The method is for handling an SSB from the network node 110 in the wireless communications network 100. The UE 120 operates with a reduced bandwidth. This means that UE 120 is a reduced bandwidth UE. The reduced bandwidth may e.g., comprise MHz or 3 MHz in FR1, and 50 MHz or 40 MHz in FR2.

The method comprises the following actions, which actions may be taken in any suitable order. Optional actions are referred to as dashed boxes in FIG. 3.

Action 301

The UE 120 detects an SSB from the network node 110. The UE 120 further detects that a bandwidth of the SSB is larger than the bandwidth of the UE 120. This may be determined by pre-defined and/or known bandwidth and Subcarrier Spacing (SCS) of the SSB. E.g., the UE 120 knows that the bandwidth of SSB may be 3.6 MHz or 7.2 MHz and it may compare with its maximum bandwidth.

This means that the UE 120 is not capable to receive the SSB since it is too large. However, if the UE 120 according to embodiments herein, reduces the SSB by skipping a part of it which then not will be received or decoded, the UE 120 will be capable to receive the reduced SSB. See below actions.

Action 302

The UE 120 determines which part of the SSB to skip to make the bandwidth of the SSB equal or smaller than the bandwidth of the UE 120, such that the UE 120 is capable to receive the SSB. It should be noted that the UE 120 may determine which part of the SSB to skip by obtaining the determined part of the SSB to skip from a network node or a distributed node.

The UE 120 is capable to receive the SSB if the bandwidth of the SSB is equal or smaller than the bandwidth of the UE 120. The wording “skip a part of the SSB to be received” when used herein means that the UE 120 ignores, punctures, or not receives that part of SSB and only decodes the remaining parts. The part of the SSB to be skipped is determined based on a predicted decoding performance of the SSB. The UE 120 will not just skip any part of the SSB, the UE 120 will consider the predicted decoding performance of the SSB. The UE 120 may then determine to skip the part that affects the predicted decoding performance as little as possible and, in this way, receive the part of the SSB that gives the best decoding performance. This will be explained more in detail below.

In some embodiments, the decoding performance of the SSB is predicted based on any one or more out of: an error probability of the decoding, parameters and configuration related to the SSB, e.g., frequency location, periodicity, etc., battery life of the UE 120, UE 120 performance requirements, and UE 120 capabilities.

It is an aim for the UE 120 to determine the skipped part such that it involves as small as possible impact on the decoding performance of the SSB when received. In some embodiments this may comprise that the determining of which part of the SSB to be skipped is performed such that the predicted decoding of the SSB achieves a performance that is any one out of:
above a first threshold,
as high as possible above the first threshold, or
such that an impact on the decoding is minimized.

In some embodiments, the UE 120 determines which part of the SSB to be skipped by determining which part or parts of the SSB to be skipped. This means that the part of the SSB to be skipped comprises one or more parts. The UE 120 may e.g., determine different parts of the SSB to be skipped. In some of these embodiments, the part or parts of the SSB to be skipped may comprise any one out of:
the first q subcarriers of the SSB,
the last q subcarriers of the SSB,
the first q_{L} subcarriers and the last q_{R} subcarriers of the SSB,

where q_{L}+q_{R}=q.

In some embodiments, the parts of the SSB to be skipped comprises the first q_{L} subcarriers and the last q_{R} subcarriers of the SSB, wherein:
one half of the subcarriers to be skipped are comprised in the first q_{L} subcarriers, and
the other half of the subcarriers to be skipped are comprised in the last q_{R} subcarriers of the SSB.

In some embodiments, the part of the SSB to be skipped is determined such that any one or more out of a PSS, an SSS, and a PBCH, comprised in the SSB are least affected or not affected.

It should be noted that determining which part of the SSB to skip and receive the rest of the parts of the SSB, may also cover determining which part of the SSB to receive and skip the rest of the parts of the SSB.

Action 303

The UE 120 may send a message to the network node 110. The message indicates the part or parts of the SSB that are determined to be skipped in order to make the bandwidth of the SSB equal or smaller than the bandwidth of the UE 120, such that the UE 120 is capable to receive the SSB.

The network node 110 may use this information when sending SSBs to other UEs. This is described below.

Action 304

In some embodiments, subsequent SSBs from the network node 110 are detected in a periodicity comprising a time interval. In some of these embodiments, the UE 120 changes the skipped part or parts of the subsequent SSBs within the time interval, so that the skipped part or parts of the SSB in some or all of the subframes are non-overlapping or partially overlapping. This makes it possible for the UE 120 to receive different parts of the SSB at different times which may be combined and construct the entire SSB.

This an advantage since the entire SSB can be decoded thus preventing the performance loss.

Action 305

When the UE 120 has skipped the determined part of the SSB and made the bandwidth of the SSB equal or smaller than the bandwidth of the UE 120, the UE 120 is capable of receiving it. The UE 120 may then receive the SSB in which the determined part or parts are skipped.

### Method in the Network Node 110

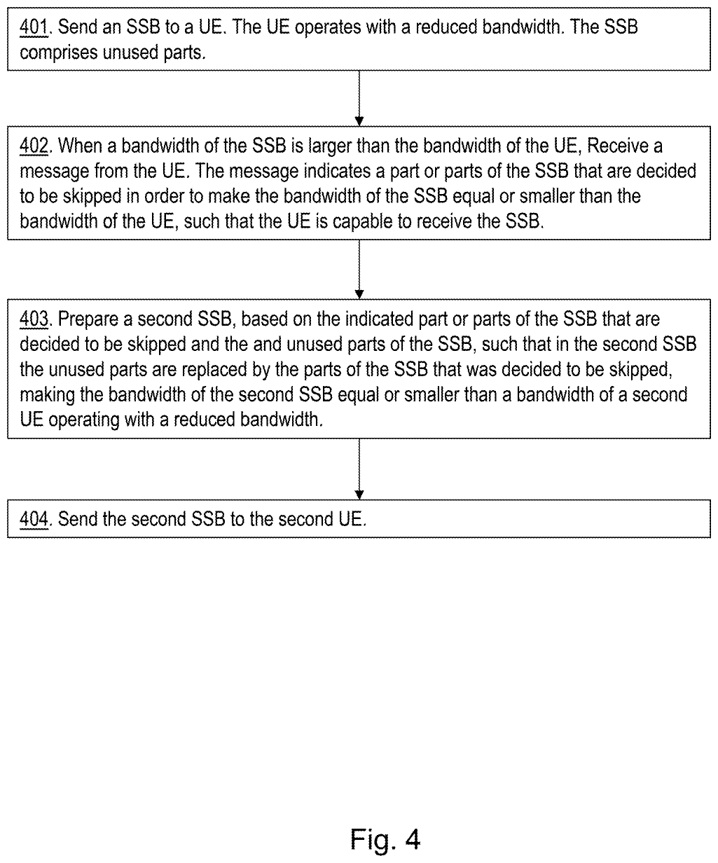

FIG. 4 shows example embodiments of a method performed by the network node 110 for handling SSBs in the wireless communications network 100. The method comprises the following actions, which actions may be taken in any suitable order. Optional actions are referred to as dashed boxes in FIG. 4.

Action 401

The network node 110 sends an SSB to the UE 120. The SSB comprises unused parts. As mentioned above, the UE 120 operates with a reduced bandwidth.

Unused parts of the SSB means REs which are not used for any data transmissions and are allocated with zero power when transmitting a typical SSB.

The SSB will be detected by the UE 120 as described above.

Action 402

The network node 110 receives a message from the UE 120. The message is received when a bandwidth of the SSB is larger than the bandwidth of the UE 120. The message indicates a part or parts of the SSB that are determined to be skipped in order to make the bandwidth of the SSB equal or smaller than the bandwidth of the UE 120, such that the UE 120 is capable to receive the SSB.

In some embodiments, the part or parts of the SSB to be skipped comprises any one out of:
the first q subcarriers of the SSB,
the last q subcarriers of the SSB,
the first q_{L} subcarriers and the last q_{R} subcarriers of the SSB,

where q_{L}+q_{R}=q.

In some embodiments, the parts of the SSB to be skipped comprises the first q_{L} subcarriers and the last q_{R} subcarriers of the SSB, wherein:
one half of the subcarriers to be skipped are comprised in the first q_{L} subcarriers, and
the other half of the subcarriers to be skipped are comprised in the last q_{L} subcarriers of the SSB.

Action 403

The network node 110 prepares a second SSB such that the second UE 122 is capable to receive the SSB. This is an SSB for another UE, the second UE 122. The network node 120 will learn from the skipped part of the earlier SSB to the UE 120, to adapt the second SSB for the second UE 122 which also operates with a reduced bandwidth. The second SSB is prepared based on the indicated part or parts of the SSB that are determined to be skipped and the unused parts of the SSB. The second SSB is prepared such that in the second SSB the unused parts are replaced by the parts of the SSB that was determined to be skipped. This will make the bandwidth of the second SSB equal or smaller than a bandwidth of the second UE 122. The second UE 122 operates with a reduced bandwidth.

Action 403

The network node 110 sends the second SSB to the second UE 122.

The above embodiments will now be further explained and exemplified below. The embodiments below may be combined with any suitable embodiment above.

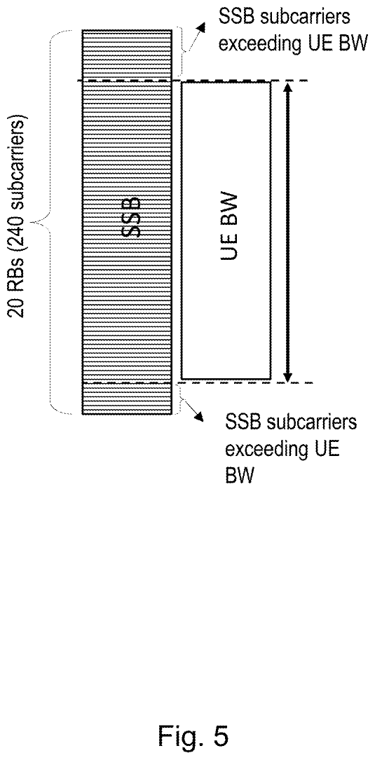

As discussed in the previous section, in some configurations the reduced BW UEs, such as the UE 120, may only receive a portion of a SSB configured for a legacy NR UE. This is illustrated in FIG. 5. This may relate to and may be combined with Action 301 and 401 described above. FIG. 5 illustrates an SSB of 20 RBs, exceeding the UE 120 bandwidth. The UE 120 bandwidth is referred to as UE BW in the figure.

E.g. due to redundancy introduced in the channel coding, the UE 120 operating with a reduced bandwidth may still recover most of the data of the SSB by not receiving all parts, e.g. all subcarriers, of the SSB according to embodiments herein. Specifically, at high SNRs the SSB decoding probability may still be high despite skipping, e.g. loosing, a part or parts, e.g. several REs of the SSB.

Some first embodiments of efficient skipping or puncturing a part of the SSB.

The below text may relate to and may be combined with Action 302 described above. As mentioned above, the UE 1200 will determine 302 which part of the SSB to skip to make the bandwidth of the SSB equal or smaller than the bandwidth of the UE 120, such that the UE 120 is capable to receive the SSB. From the UE 120 point of view this may mean that, if the UE 120 cannot receive the full SSB because of its reduced BW, it may determine to receive e.g. the part of the SSB which gives the best decoding performance. Another way of saying it, the UE 120 may choose to receive parts such as a set of resources, at Resource Blocks (RBs) and/or subcarriers of the SSB, at the receiver of the UE 120, less than the resources used by the SSB and skip a part comprising the rest of resources. Such skipping of a part of the SSB, such as e.g., resource skipping, may be done at subcarrier-level and/or RB-level at the SSB. Clearly, RB-level, where 1 RB=12 subcarriers of the SSB, is a special case of subcarrier-level skipping approach. The goal is to identify, also referred to as identify, which resources to skip and which resources to be received in order to ensure a minimum performance loss in the SSB decoding. Let Bᵤ be the effective bandwidth, excluding any guardband if needed, and Sᵤ be the number of subcarriers of the UE 120. Similarly, let B_{c}, and S_{c} be the bandwidth and number of subcarriers of the SSB. When Bᵤ<B_{c}, the UE 120 needs to skip a number of subcarriers of the SSB but receive the rest. At subcarrier-level, the number of skipped subcarriers is (S_{c}−Sᵤ).

To avoid bandwidth fragmentation, the UE 120 may in some embodiments, determine to receive contiguous RBs. Hence, one part of the SSB comprising subcarriers on the high edge, i.e., subcarriers with high indices, and/or one part of the SSB comprising subcarriers on low edge, i.e., subcarriers with low indices, may be determined to be skipped, i.e. not received by the reduced BW UE 120.

Let q be the part of the SSB to skip, comprising the total number of subcarriers per OFDM symbol of the SSB which need to be skipped at the receiver. The value q is determined based on the UE 120 BW, the SSB BW, and any guardband which may be required for receiving SSB, see Table 2 for example. In particular, for effective UE BW Bᵤ, the total number of skipped SSB subcarriers should be at least:

$$q = ceil ( 240 - \frac{{B}_{u} [ kHz ]}{S C {S}_{s s b} [ kHz ]} )$$

where ceil (.) is the ceiling function, and SCS_{ssb} is the SSB subcarrier spacing. A ceiling function when used herein e.g. means it gives the smallest nearest integer that is greater than or equal to the specified value.

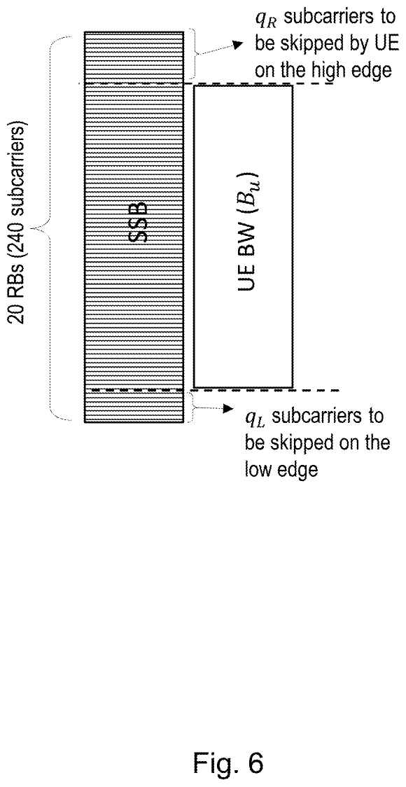

When receiving an SSB that exceeds the bandwidth of the UE 120, the UE 120 may consider at least one of the following options:
The first q subcarriers (lowest indices) of the SSB are skipped.
The last q subcarriers (highest indices) of the SSB are skipped.
The first q_{L} subcarriers and the last q_{R} subcarriers of the SSB are skipped (see FIG. 6), where q_{L}+q_{R}=q.

FIG. 6 illustrates an example of skipping of two parts of the SSB comprising skipping SSB subcarriers at the receiver of the UE 120, in total q_{L}+q_{R}=q are skipped. In some embodiments, the values of q_{L} and q_{R} are properly determined by the UE 120 to ensure a minimum SSB decoding performance loss. The UE 120 determines to receive resources within the bandwidth of the SSB, such that it can decode the SSB with acceptable performance, e.g. relating to error probability. This error probability may be determined by the UE 120 performance requirement, e.g., specified in the standards, or the UE 120 may determine by itself, e.g., based on service, battery life, etc., requirements.

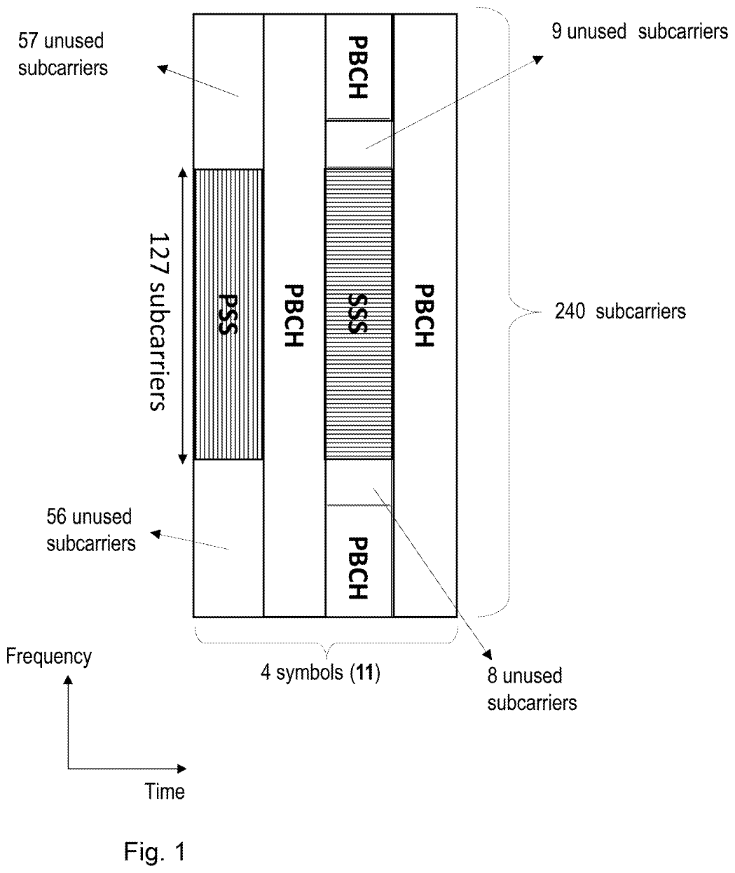

To properly decode an SSB by the reduced-BW UE 120, it should preferred be ensured that PSS and SSS are least affected, and preferably not affected. Moreover, to minimize the impact on PBCH, the minimum number of used SSB subcarriers should be skipped. However, there are also several unused REs in SSB which the UE 120 rather should determine to skip. To this end, considering the positions of PSS/SSS/PBCH, shown in FIG. 1, and the total number of subcarriers which need to be skipped (q), the following rules may be used by the UE 120, e.g. at the receiver of the UE 120:
If q≤48, the UE 120 receiver may skip subcarriers from the low edge, e.g. low index subcarriers, high edge, e.g. high index subcarriers, or both edges.
If 49≤q≤56, the UE 120 receiver may skip subcarriers from the low edge or from the high edge.
If q=57, the UE 120 receiver may skip subcarriers from the high edge.
If 58≤q≤113, the UE 120 receiver may skip up to 57 subcarriers from high edge, and remaining (up to 56) subcarriers from low edge to avoid impact on PSS/SSS. In particular, to ensure that the minimum number of used subcarriers are skipped, the receiver can skip 57 subcarriers from the high edge and (q−57) subcarriers from the low edge.
If q>113, the UE 120 receiver may skip at least 57 subcarriers from high edge, and at least 56 subcarriers from the low edge.

The above rules ensure a minimum impact on PSS/SSS, as well as on PBCH by minimizing the number of used subcarriers which are skipped, i.e., unused subcarriers are skipped when possible.

In some other embodiments, the determining of which part comprising subcarriers of the SSB to skip, is performed such that the detected and/or received PSS and/or SSS of the SSB is centered in the frequency domain with respect to the UE 120 bandwidth.

In another embodiment, the value of Bᵤ and q may be adapted according to the coverage condition. If the UE 120 is in good coverage condition, an aggressive subcarrier skipping might not affect the performance of SSB detection. An aggressive subcarrier skipping when used herein may mean a simple puncturing approach, i.e., without optimization, that may result in relatively high performance loss. It should be noted that the path loss in a cell may vary by approximately 80-100 dB. Thus, an aggressive subcarrier skipping is feasible for most of the UEs such as e.g. the UE 120, in a cell.

Moreover, the following related embodiments may be envisioned:
For BW limited UE such as the UE 120, some part of a transmitted SSB may not be received. From UE 120 perspective, this part may be considered as skipped, also referred to as punctured and corresponds to some punctured bit positions of an output of a rate matching for polar code. This means that the bits have zero values. This is an advantage since it simplifies the decoding process for the UE 120.
The BW limited UE 120 may perform an insertion of zeros as soft values, i.e., Log-Likelihood Ratios (LLRs), before sending the LLRs to the polar decoder, for both the corresponding positions of the bits punctured at the output of the polar encoder (for rate matching), and the corresponding positions that the UE 120 skipped receiving. This is an advantage since it simplifies the decoding process for the UE 120.
In addition, the insertion of zero soft-bit values may be performed in all or some of the positions corresponding to the punctured REs of the SSB, i.e. the parts that are not received by the UE 120.

Some second embodiment relating to utilizing unused resource elements

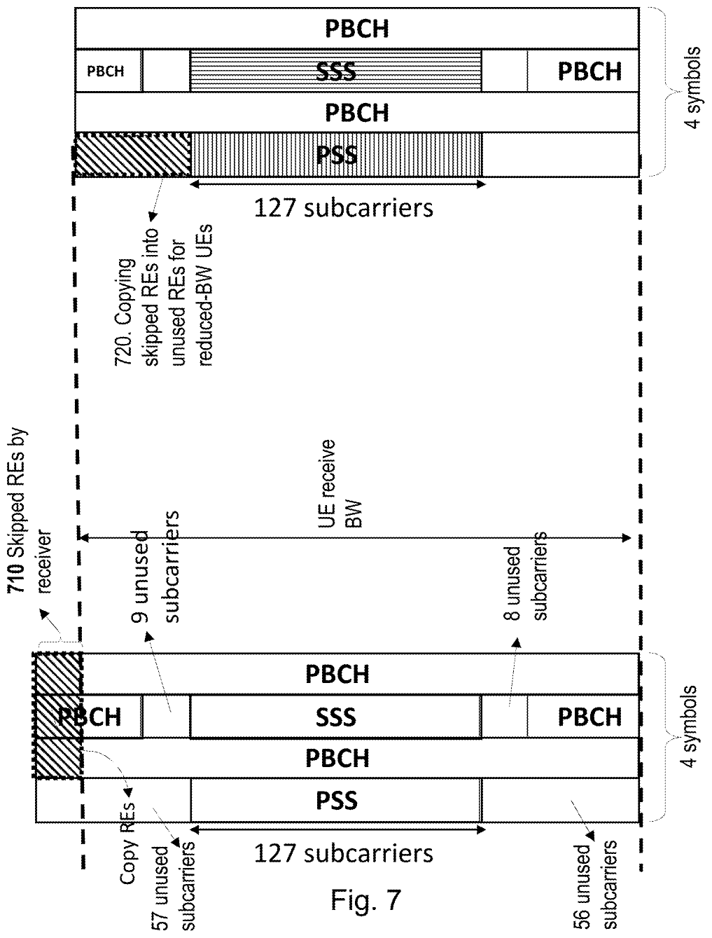

The below text may relate to and may be combined with Actions 402-404 described above. In these embodiments, the network node 110 utilizes the unused REs of an SSB to facilitate SSB reception by reduced-BW UEs such as the second UE 122. In this method, both legacy UEs and reduced-bandwidth UEs may receive full SSB information but additional time-frequency resources are needed for SSB transmission no matter whether there are reduced-bandwidth UEs or not. A non-limiting example of this approach is illustrated in FIG. 7. The mapping of the skipped Res, skipped by the UE 120, and the new used REs for reduced-bandwidth UEs such as the second UE 122, may be pre-defined at both network and UE sides. FIG. 7 illustrates utilizing unused SSB REs for reduced bandwidth UEs for receiving SSB.

It can be seen that the part comprising REs skipped by the UE 120 is copied 710 by the network node 110 and pasted 720 into unused REs for reduced-BW UEs such as the second UE 122.

In another embodiment, the network node 110 utilizes the REs which are not in the existing SSB to facilitate SSB reception by reduced-BW UEs, for example REs or partial REs in a first symbol after a legacy SSB. The mapping of the skipped REs and the new used REs for reduced-BW UEs such as the second UE 122 may be pre-defined at both network and UE sides.

Some third embodiments relating to multi-stage reception of SSB

As described above, the SSB periodicity may be any of {5, 10, 20, 40, 80, 160} ms. The contents of MIB carried by PBCH in the SSB is expected to be the same over an 80 ms time interval, i.e., over 8 subframes. Due to this reason, PBCH blocks transmitted in different subframes within this 80 ms interval may be jointly decoded to achieve a better performance. This is since different copies of the SSB may be received in different time instances and jointly combined and decoded. To be jointly decoded means that decoding is done in multiple time instances, i.e., accumulating information for better decoding performance.

In some embodiments, the UE 120 may change the skipped subcarriers of SSB within e.g., 80 ms interval, so that the skipped portions of the SSB in some or all of the subframes are non-overlapping or partially overlapping. This means that different portions of the SSB are decoded in different times which overall is equivalent to receiving the entire SSB thus preventing the performance loss. Note that this may require retuning of the UE's 120 center frequency in certain subframes to receive different portions of the SSB, if Bᵤ<B_{c}. In these embodiments, the transmission gap may be needed to support frequency hopping, so the network node 110 needs to know whether the UE 120 supports wider bandwidth or frequency hopping for SSB detection. In this case, a UE 120 capability report is needed. The UE 120 may report its capability of frequency hopping for SSB detection to the network node 110. The transmission gap to support frequency hopping may be needed.

In a sub-embodiment, the UE 120 performs RF retuning to decode different parts of SSB in multiple stages. For example, in a first stage SSS and/or PSS part of the SSB is decoded and in later stages other parts of SSB will be decoded. Moreover, some parts of SSB may be decoded multiple times to improve the detection performance. The UE 120 may also determine to skip a part of the SSB to minimize the required RF retuning.

Some embodiments herein may be illustrated by using the following example:

Let q=50, then, as described in the first embodiments, the UE 120 determines to skip 50 subcarriers from the low edge or 50 subcarriers from the high edge. In one example of these embodiments, it is recommended that in the 8 subframes within the 80 ms interval, the UE 120 will determine to skip 50 subcarriers from the low edge in the first 4 subframes, and 50 subcarriers from the high edge in the remaining 4 subframes. This results in the UE 120 receiving the entire portion, i.e., bandwidth B_{c}, of the SSB within the 80 ms interval.

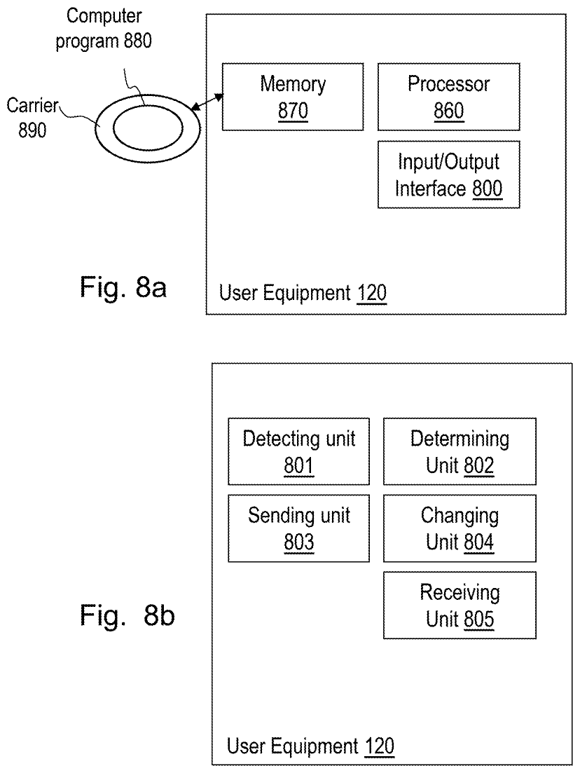

To perform the method actions above, the UE 120 is configured to handle an SSB from the network node 110 in the wireless communications network 100. The UE 120 is adapted to operate with a reduced bandwidth. The UE 120 may comprise an arrangement depicted in FIGS. 8a and 8b.

The UE 120 may comprise an input and output interface 800 configured to communicate in the wireless communication network 100, e.g., with the network node 110. The input and output interface 800 may comprise a wireless receiver (not shown) and a wireless transmitter (not shown).

The UE 120 may further be configured to, e.g. by means of a detecting unit 801 in the UE 120, detect an SSB from the network node 110, and that a bandwidth of the SSB is larger than the bandwidth of the UE 120.

The UE 120 may further be configured to, e.g. by means of a determining unit 802 in the UE 120, determine which part of the SSB to skip to make the bandwidth of the SSB equal or smaller than the bandwidth of the UE 120, such that the UE 120 is capable to receive the SSB. The part of the SSB to be skipped is adapted to be determined based on a predicted decoding performance of the SSB.

The UE 120 may further be configured to, e.g. by means of the determining unit 802 in the UE 120, determine which part of the SSB to be skipped such that the predicted decoding of the SSB achieves a performance that is any one out of:
above a first threshold,
as high as possible above the first threshold, or
such that an impact on the decoding is minimized.

The UE 120 may further be configured to, e.g. by means of the determining unit 802 in the UE 120, determine which part of the SSB to be skipped by: determining which part or parts of the SSB to be skipped, and wherein the part or parts of the SSB to be skipped is/are adapted to comprise any one out of:
the first q subcarriers of the SSB,
the last q subcarriers of the SSB,
the first q_{L} subcarriers and the last q_{R} subcarriers of the SSB,

where q_{L}+q_{R}=q.

In some embodiments, decoding performance of the SSB is adapted to be predicted based on any one or more out of:

an error probability of the decoding, parameters and configuration related to the SSB, battery life of the UE 120, UE 120 performance requirements and UE 120 capabilities.

In some embodiments, the parts of the SSB to be skipped are adapted to comprise the first q_{L} subcarriers and the last q_{R} subcarriers of the SSB, wherein:
one half of the subcarriers to be skipped are adapted to be comprised in the first q_{L} subcarriers, and
the other half of the subcarriers to be skipped are adapted to be comprised in the last q_{R} subcarriers of the SSB.

In some embodiments, the part of the SSB to be skipped is adapted to be determined such that any one or more out of a PSS, an SSS, and a PBCH, comprised in the SSB are least affected or not affected.

The UE 120 may further be configured to, e.g. by means of a sending unit 803 in the UE 120, send a message to the network node 110, which message is adapted to indicate the part or parts of the SSB that are determined to be skipped in order to make the bandwidth of the SSB equal or smaller than the bandwidth of the UE 120, such that the UE 120 is capable to receive the SSB.

In some embodiments, subsequent SSBs from the network node 110 are adapted to be detected in a periodicity comprising a time interval. The UE 120 may further be configured to, e.g. by means of a changing unit 804 in the UE 120, change the skipped part or parts of the subsequent SSBs within the time interval, so that the skipped part or parts of the SSB in some or all of the subframes are non-overlapping or partially overlapping.

The UE 120 may further be configured to, e.g. by means of a receiving unit 805 in the UE 120, receive SSB in which the determined part or parts are skipped.

The embodiments herein may be implemented through a respective processor or one or more processors, such as the processor 860 of a processing circuitry in the UE 120 depicted in FIG. 8a, together with respective computer program code for performing the functions and actions of the embodiments herein. The program code mentioned above may also be provided as a computer program product, for instance in the form of a data carrier carrying computer program code for performing the embodiments herein when being loaded into the UE 120. One such carrier may be in the form of a CD ROM disc. It is however feasible with other data carriers such as a memory stick. The computer program code may furthermore be provided as pure program code on a server and downloaded to the UE 120.

The UE 120 may further comprise a memory 870 comprising one or more memory units. The memory 870 comprises instructions executable by the processor in UE 120.

The memory 870 is arranged to be used to store e.g. information, indications, data, configurations, SSBs/part(s) of SSBs, messages, and applications to perform the methods herein when being executed in the UE 120.

In some embodiments, a computer program 880 comprises instructions, which when executed by the respective at least one processor 860, cause the at least one processor of the UE 120 to perform the actions above.

In some embodiments, a respective carrier 890 comprises the respective computer program 880, wherein the carrier 890 is one of an electronic signal, an optical signal, an electromagnetic signal, a magnetic signal, an electric signal, a radio signal, a microwave signal, or a computer-readable storage medium.

Those skilled in the art will appreciate that the units in the UE 120 described above may refer to a combination of analog and digital circuits, and/or one or more processors configured with software and/or firmware, e.g. stored in the UE 120, that when executed by the respective one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a system-on-a-chip SoC.

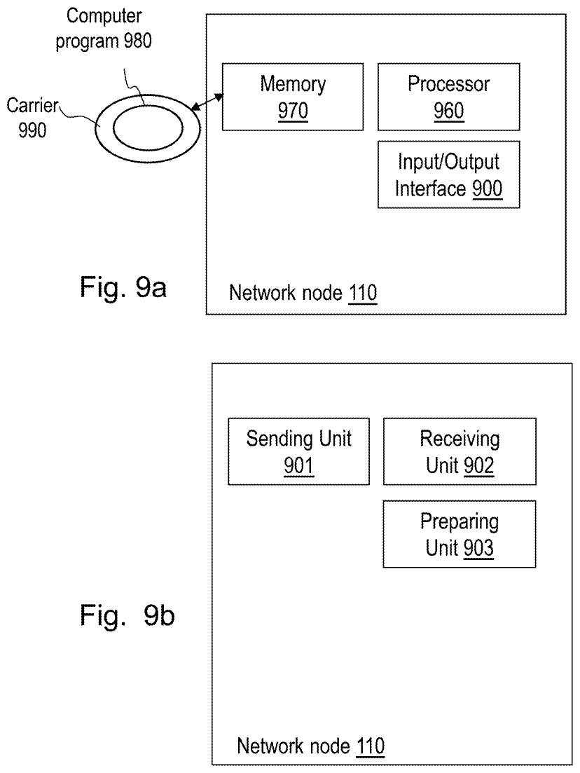

To perform the method actions above, the network node 110 is configured to handle SSBs in a wireless communications network 100. The network node 110 may comprise an arrangement depicted in FIGS. 9a and 9b.

The network node 110 may comprise an input and output interface 900 configured to communicate in the wireless communication network 100, e.g., with the UE 120. The input and output interface 900 may comprise a wireless receiver (not shown) and a wireless transmitter (not shown).

The network node 110 may further be configured to, e.g. by means of a sending unit 901 in the network node 110, send an SSB to the UE 120. The UE 120 is adapted to operate with a reduced bandwidth. The SSB comprises unused parts,

The network node 110 may further be configured to, e.g. by means of a receiving unit 902 in the network node 110, when a bandwidth of the SSB is larger than the bandwidth of the UE 120, receive a message from the UE 120. The message is adapted to indicate a part or parts of the SSB that are determined to be skipped in order to make the bandwidth of the SSB equal or smaller than the bandwidth of the UE 120, such that the UE 120 is capable to receive the SSB.

The network node 110 may further be configured to, e.g. by means of a preparing unit 903 in the network node 110, a second SSB such that the UE 120 is capable of receiving the SSB, based on the indicated part or parts of the SSB that are determined to be skipped and the unused parts of the SSB, such that in the second SSB the unused parts are replaced by the parts of the SSB that was determined to be skipped, making the bandwidth of the second SSB equal or smaller than a bandwidth of a second UE 122 operating with a reduced bandwidth.

The network node 110 may further be configured to, e.g. by means of the sending unit 901 in the network node 110, send the second SSB to the second UE 122.

In some embodiments, the part or parts of the SSB to be skipped is/are adapted to comprise any one out of:
the first q subcarriers of the SSB,
the last q subcarriers of the SSB,
the first q_{L} subcarriers and the last q_{R} subcarriers of the SSB, where q_{L}+q_{R}=q.

In some embodiments, the parts of the SSB to be skipped are adapted to comprise the first q_{L} subcarriers and the last q_{R} subcarriers of the SSB, wherein:
one half of the subcarriers to be skipped are adapted to be comprised in the first q_{L} subcarriers, and
the other half of the subcarriers to be skipped are adapted to be comprised in the last q_{R} subcarriers of the SSB.

The embodiments herein may be implemented through a respective processor or one or more processors, such as the processor 960 of a processing circuitry in the network node 110 depicted in FIG. 9a, together with respective computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 970 comprising one or more memory units. The memory 970 comprises instructions executable by the processor in network node 110. The memory 970 is arranged to be used to store e.g., information, indications, data, configurations, SSBs/part(s) of SSBs, messages, and applications to perform the methods herein when being executed in the network node 110.

In some embodiments, a computer program 980 comprises instructions, which when executed by the respective at least one processor 960, cause the at least one processor of the network node 110 to perform the actions above.

In some embodiments, a respective carrier 990 comprises the respective computer program 980, wherein the carrier 990 is one of an electronic signal, an optical signal, an electromagnetic signal, a magnetic signal, an electric signal, a radio signal, a microwave signal, or a computer-readable storage medium.

Those skilled in the art will appreciate that the units in the network node 110 described above may refer to a combination of analog and digital circuits, and/or one or more processors configured with software and/or firmware, e.g. stored in the network node 110, that when executed by the respective one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a system-on-a-chip SoC.

With reference to FIG. 10, in accordance with an embodiment, a communication system includes a telecommunication network 3210, such as a 3GPP-type cellular network, e.g. wireless communications network 100, which comprises an access network 3211, such as a radio access network, and a core network 3214. The access network 3211 comprises a plurality of base stations 3212a, 3212b, 3212c, such as AP STAs NBs, eNBs, gNBs or other types of wireless access points, each defining a corresponding coverage area 3213a, 3213b, 3213c. Each base station 3212a, 3212b, 3212c, e.g. the network node 110, is connectable to the core network 3214 over a wired or wireless connection 3215. A first user equipment (UE), e.g. the UE 120, such as a Non-AP STA 3291 located in coverage area 3213c is configured to wirelessly connect to, or be paged by, the corresponding base station 3212c. A second UE 3292, e.g. the second UE 122, such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-5 implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 10 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

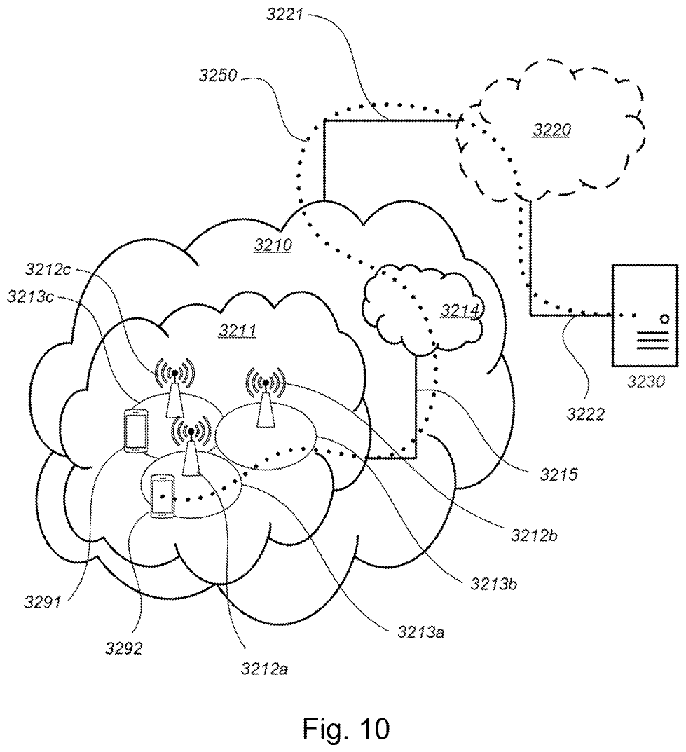

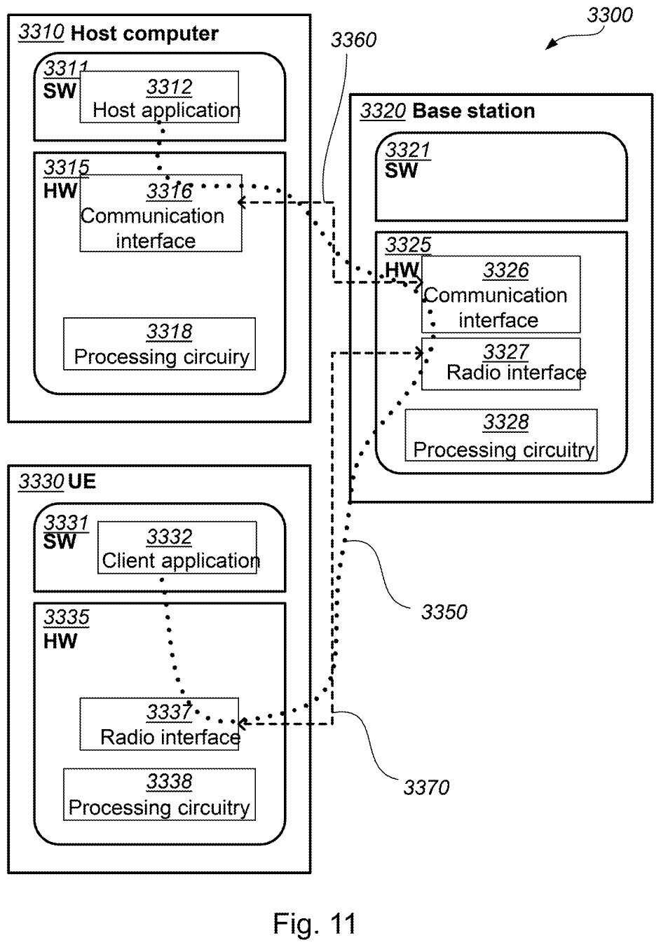

Example implementations, in accordance with an embodiment, of the UE, base station and host computer discussed in the preceding paragraphs will now be described with reference to FIG. 11. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 11) served by the base station 3320. The communication interface 3326 may be configured to facilitate a connection 3360 to the host computer 3310. The connection 3360 may be direct or it may pass through a core network (not shown in FIG. 11) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 11 may be identical to the host computer 3230, one of the base stations 3212a, 3212b, 3212c and one of the UEs 3291, 3292 of FIG. 10, respectively. This is to say, the inner workings of these entities may be as shown in FIG. 11 and independently, the surrounding network topology may be that of FIG. 10.

In FIG. 11, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as e.g. the applicable corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

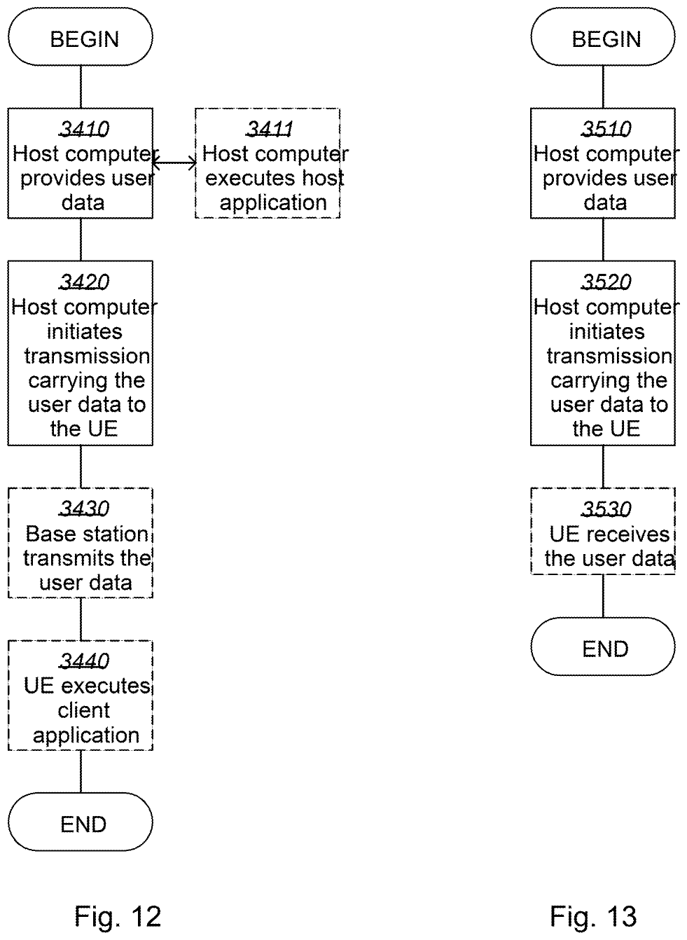

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 10. For simplicity of the present disclosure, only drawing references to FIG. 12 will be included in this section. In a first step 3410 of the method, the host computer provides user data. In an optional sub step 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 10. For simplicity of the present disclosure, only drawing references to FIG. 13 will be included in this section. In a first step 3510 of the method, the host computer provides user data. In an optional sub step (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

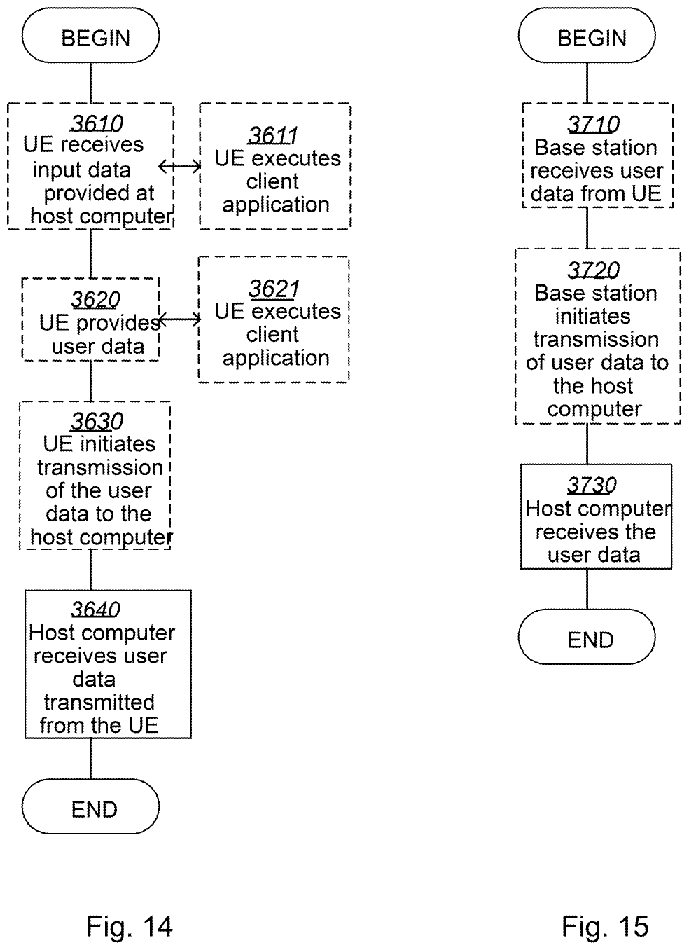

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 10. For simplicity of the present disclosure, only drawing references to FIG. 14 will be included in this section. In an optional first step 3610 of the method, the UE receives input data provided by the host computer. Additionally or alternatively, in an optional second step 3620, the UE provides user data. In an optional sub step 3621 of the second step 3620, the UE provides the user data by executing a client application. In a further optional sub step 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third sub step 3630, transmission of the user data to the host computer. In a fourth step 3640 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 10. For simplicity of the present disclosure, only drawing references to FIG. 15 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

### ABBREVIATION EXPLANATION

BW Bandwidth
BWP Bandwidth Part
CORESET Control Resource Set
CSS Common Search Space
DCI Downlink Control Information
Msg2 Message 2 during random access
NR New Radio
NR-RedCap Reduced Capability NR Devices
PDCCH Physical Downlink Control Channel
PUCCH Physical Uplink Control Channel
PUSCH Physical Uplink Shared Channel
RE Resource Element
REG Resource Element Group
RF Radio Frequency
RACH Random Access Channel
PRACH Physical Random Access Channel
PRB Physical Resource Block
RAR Random Access Response
SCS Subcarrier Spacing
SSB Synchronization Signal Block
UE User equipment

1. A method performed by a User Equipment, UE, for handling a Synchronization Signal Block, SSB, from a network node in a wireless communications network, which UE operates with a reduced bandwidth, the method comprising:
detecting an SSB from the network node, and that a bandwidth of the SSB is larger than the bandwidth of the UE;
determining which part of the SSB to skip to make the bandwidth of the SSB equal or smaller than the bandwidth of the UE, such that the UE is capable of receiving the SSB; and
the part of the SSB to be skipped is determined based on a predicted decoding performance of the SSB.

2. The method according to claim 1, wherein the determining of which part of the SSB to be skipped is performed such that the predicted decoding of the SSB achieves a performance that is any one out of:
above a first threshold; and
as high as possible above the first threshold; and
such that an impact on the decoding is minimized.

3. The method according to claim 1, wherein the decoding performance of the SSB is predicted based on any one or more out of:
an error probability of the decoding
parameters and configuration related to the SSB;
battery life of the UE;
UE performance requirements and
UE capabilities.

4. The method according to claim 1, wherein the determining of which part of the SSB to be skipped comprises: determining which part or parts of the SSB to be skipped, and wherein the part or parts of the SSB to be skipped comprises any one out of:
the first q subcarriers of the SSB;
the last q subcarriers of the SSB; and
the first q_{L} subcarriers and the last q_{R} subcarriers of the SSB,
where q_{L}+q_{R}=q.

5. The method according to claim 4, wherein the parts of the SSB to be skipped comprises the first q_{L} subcarriers and the last q_{R} subcarriers of the SSB, wherein:
one half of the subcarriers to be skipped are comprised in the first q_{L} subcarriers; and
the other half of the subcarriers to be skipped are comprised in the last q_{R} subcarriers of the SSB.

6. The method according to claim 1, wherein the part of the SSB to be skipped is determined such that any one or more out of a Primary Synchronization Signal, PSS, a Secondary Synchronization Signal, SSS, and a Physical Broadcast Channel, PBCH, comprised in the SSB are least affected or not affected.

7. The method according to claim 1, further comprising:
sending a message to the network node, which message indicates the part or parts of the SSB that are determined to be skipped in order to make the bandwidth of the SSB equal or smaller than the bandwidth of the UE, such that the UE is capable to receive the SSB.

8. The method according to claim 1, wherein subsequent SSBs from the network node are detected in a periodicity comprising a time interval, the method further comprising:
changing the skipped part or parts of the subsequent SSBs within the time interval, so that the skipped part or parts of the SSB in some or all of the subframes are non-overlapping or partially overlapping.

9. The method according to claim 1, further comprising:
receiving SSB in which the determined part or parts are skipped.

10-11. (canceled)

12. A method performed by a network node for handling Synchronization Signal, Blocks, SSBs, in a wireless communications network, the method comprising:
sending an SSB to a User Equipment, UE, which UE operates with a reduced bandwidth, which SSB comprises unused parts;
when a bandwidth of the SSB is larger than the bandwidth of the UE, receiving a message from the UE, which message indicates a part or parts of the SSB that are determined to be skipped in order to make the bandwidth of the SSB equal or smaller than the bandwidth of the UE, such that the UE is capable of receiving the SSB;
preparing a second SSB such that a second UE is capable to receive the SSB, based on the indicated part or parts of the SSB that are determined to be skipped and the unused parts of the SSB, such that in the second SSB the unused parts are replaced by the parts of the SSB that was determined to be skipped, making the bandwidth of the second SSB equal or smaller than a bandwidth of the second UE operating with a reduced bandwidth; and
sending the second SSB to the second UE.

13. The method according to claim 12, wherein the part or parts of the SSB to be skipped comprises any one out of:
the first q subcarriers of the SSB;
the last q subcarriers of the SSB; and
the first q_{L} subcarriers and the last q_{R} subcarriers of the SSB,
where q_{L}+q_{R}=q.

14. The method according to claim 13, wherein the parts of the SSB to be skipped comprises the first q_{L} subcarriers and the last q_{R} subcarriers of the SSB, wherein:
one half of the subcarriers to be skipped are comprised in the first q_{L} subcarriers; and
the other half of the subcarriers to be skipped are comprised in the last q_{R} subcarriers of the SSB.

15-16. (canceled)

17. A User Equipment, UE, configured to handle a Synchronization Signal Block, SSB, from a network node in a wireless communications network, which UE is adapted to operate with a reduced bandwidth, the UE further being configured to:
detect an SSB from the network node, and that a bandwidth of the SSB is larger than the bandwidth of the UE;
determine which part of the SSB to skip to make the bandwidth of the SSB equal or smaller than the bandwidth of the UE, such that the UE is capable to receive the SSB; and
the part of the SSB to be skipped is determined based on a predicted decoding performance of the SSB.

18. The UE according to claim 17 further configured to determine which part of the SSB to be skipped such that the predicted decoding of the SSB achieves a performance that is any one out of:
above a first threshold;
as high as possible above the first threshold; and
such that an impact on the decoding is minimized.

19. The UE according to claim 17, wherein the decoding performance of the SSB is predicted based on any one or more out of:
an error probability of the decoding;
parameters and configuration related to the SSB;
battery life of the UE;
UE performance requirements and
UE capabilities.

20. The UE according to claim 17, further configured to determine which part of the SSB to be skipped by determining which part or parts of the SSB to be skipped, and wherein the part or parts of the SSB to be skipped comprise any one out of:
the first q subcarriers of the SSB;
the last q subcarriers of the SSB; and
the first q_{L} subcarriers and the last q_{R} subcarriers of the SSB,
where q_{L}+q_{R}=q.

21. The UE according to claim 20, wherein the parts of the SSB to be skipped comprise the first q_{L} subcarriers and the last q_{R} subcarriers of the SSB, wherein:
one half of the subcarriers to be skipped are comprised in the first q_{L} subcarriers; and
the other half of the subcarriers to be skipped are comprised in the last q_{R} subcarriers of the SSB.

22. The UE according to claim 17, wherein the part of the SSB to be skipped is adapted to be determined such that any one or more out of a Primary Synchronization Signal, PSS, a Secondary Synchronization Signal, SSS, and a Physical Broadcast Channel, PBCH, comprised in the SSB are least affected or not affected.

23. The UE according to claim 17, further configured to:
send a message to the network node, which message indicates the part or parts of the SSB that are determined to be skipped in order to make the bandwidth of the SSB equal or smaller than the bandwidth of the UE, such that the UE is capable of receiving the SSB.

24. The UE according to claim 17, wherein subsequent SSBs from the network node are configured to be detected in a periodicity comprising a time interval, and the UE further being configured to:
change the skipped part or parts of the subsequent SSBs within the time interval, so that the skipped part or parts of the SSB in some or all of the subframes are non-overlapping or partially overlapping.

25. The UE according to claim 17, further configured to:
receive SSB in which the determined part or parts are skipped.

26. A network node configured to handle Synchronization Signal, Blocks, SSBs, in a wireless communications network, the network node further being configured to:
send an SSB to a User Equipment, UE, which UE is configured to operate with a reduced bandwidth, which SSB comprises unused parts;
when a bandwidth of the SSB is larger than the bandwidth of the UE (120), receive a message from the UE, which message indicates a part or parts of the SSB that are determined to be skipped in order to make the bandwidth of the SSB equal or smaller than the bandwidth of the UE (120), such that the UE (120) is capable of receiving the SSB;
prepare a second SSB such that a second UE is capable of receiving the SSB, based on the indicated part or parts of the SSB that are determined to be skipped and the unused parts of the SSB, such that in the second SSB the unused parts are replaced by the parts of the SSB that was determined to be skipped, making the bandwidth of the second SSB equal or smaller than a bandwidth of the second UE operating with a reduced bandwidth; and
send the second SSB to the second UE.

27. The network node according to claim 26, wherein the part or parts of the SSB to be skipped comprise any one out of:
the first q subcarriers of the SSB;
the last q subcarriers of the SSB; and
the first q_{L} subcarriers and the last q_{R} subcarriers of the SSB,
where q_{L}+q_{R}=q.

28. The network node according to claim 27, wherein the parts of the SSB to be skipped comprise the first q_{L} subcarriers and the last q_{R} subcarriers of the SSB, wherein:
one half of the subcarriers to be skipped are adapted to be comprised in the first q_{L} subcarriers; and
the other half of the subcarriers to be skipped are adapted to be comprised in the last q_{R} subcarriers of the SSB.
